(19) United States
(12) Patent Application Publication
(10) Pub. No.: US 2026/0018806 A1
(43) Pub. Date: Jan. 15, 2026

(54) Terminal, Terminal Assembly And Electrical Connection Device

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Yun (Steven) Wang, Suzhou (CN); Jianwen (Gerry) Zhang, Suzhou (CN); Weidong Zhang, Shanghai (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/266,896

(22) Filed: Jul. 11, 2025

(30) Foreign Application Priority Data
Jul. 11, 2024 (CN) 202410933579.0

(51) Int. Cl. H01R 4/02; B60L 53/16; H01R 4/60; H01R 4/62; H01R 11/01; H01R 11/05

(52) U.S. Cl. CPC H01R 4/029; B60L 53/16; H01R 4/60; H01R 4/625; H01R 11/01; H01R 11/05; H01R 2201/26

(57) ABSTRACT

A terminal includes a tubular body and a welding portion. The tubular body has a front tubular portion mating with a mating terminal and a rear tubular portion joined with an injection-molded seal. The welding portion is connected to a rear end of the tubular body and welded to a conductor of a power transmission member. The terminal is a one-piece stamped copper terminal. The nickel plating layer is formed on an entirety of the terminal. The nickel plating layer is a base plating layer of the terminal. The terminal has a mating zone at the front tubular portion, an injection molding zone at the rear tubular portion, and a welding zone at the welding portion. A silver plating layer is formed on the nickel plating layer in the mating zone. A tin plating layer is formed on the nickel plating layer in the injection molding zone.

### CROSS-REFERENCE TO RELATED APPLICATION

This application claims the benefit of Chinese Patent Application No. CN202410933579.0 filed on Jul. 11, 2024, the whole disclosure of which is incorporated herein by reference.

### FIELD OF THE INVENTION

The present invention relates to a terminal and, more particularly, to a terminal, a terminal assembly comprising the terminal, and an electrical connection device comprising the terminal assembly.

### BACKGROUND OF THE INVENTION

In the prior art, as the automotive market becomes more competitive, the control of terminal costs is becoming more and more stringent, and stamped terminals have more advantages regarding cost. Although stamped terminals have many advantages, since the stamped terminals are innovative technology, use of stamped terminals involve many technical difficulties (e.g., how to form a plating layer on the terminal). In order to ensure electrical contact performance, it is usually necessary to form a silver plating layer on the entire terminal. However, the joint performance between the silver plating layer and a silicone seal injection-molded on the terminal is poor, and it is likely to form a gap between the two, thereby reducing the waterproof sealing performance of the terminal. In addition, forming a silver plating layer on the entire terminal will increase the cost.

### SUMMARY OF THE INVENTION

A terminal includes a tubular body and a welding portion. The tubular body has a front tubular portion mating with a mating terminal and a rear tubular portion joined with an injection-molded seal. The welding portion is connected to a rear end of the tubular body and welded to a conductor of a power transmission member. The terminal is a one-piece stamped copper terminal. The nickel plating layer is formed on an entirety of the terminal. The nickel plating layer is a base plating layer of the terminal. The terminal has a mating zone at the front tubular portion, an injection molding zone at the rear tubular portion, and a welding zone at the welding portion. A silver plating layer is formed on the nickel plating layer in the mating zone. A tin plating layer is formed on the nickel plating layer in the injection molding zone.

### BRIEF DESCRIPTION OF THE DRAWINGS

The invention will now be described by way of example with reference to the accompanying figures, of which:

FIG. 1 is a perspective view of a terminal according to an exemplary embodiment;

FIG. 2 is an axial cross-sectional view of the terminal of FIG. 1;

FIG. 3 is a plan view of the terminal of FIG. 1;

FIG. 4 is a cross-sectional view of the terminal of FIG. 1;

FIG. 5 is a cross-sectional view of the terminal of FIG. 1 having a nickel plating layer formed on the terminal;

FIG. 6 is a cross-sectional view of the terminal of FIG. 1 as shown in FIG. 5 having a silver plating layer and a tin plating layer respectively formed on the nickel plating layer of FIG. 5 in a mating zone and in an injection molding zone of the terminal, with no other plating layer formed on the nickel plating layer in a welding zone of the terminal;

FIG. 7 is a cross-sectional view of an injection-molded seal formed on a rear tubular portion of the terminal of FIG. 1 as shown in FIG. 6;

FIG. 8 is a cross-sectional view of a conductor of a power transmission member welded on a welding portion of the terminal of FIG. 1 as shown in FIG. 7;

FIG. 9 is a cross-sectional view of a silver plating layer, a tin plating layer, and a silver plating layer respectively formed on a nickel plating layer in a mating zone, in an injection molding zone, and in a welding zone of a terminal according to another exemplary embodiment;

FIG. 10 is a cross-sectional view of an injection-molded seal formed on a rear tubular portion of the terminal of FIG. 9;

FIG. 11 is a cross-sectional view of a conductor of a power transmission member welded on a welding portion of the terminal of FIG. 9 as shown in FIG. 10; and

FIG. 12 is an axial cross-sectional view of a terminal assembly according to an exemplary embodiment.

### DETAILED DESCRIPTION

Exemplary embodiments of the present disclosure will be described hereinafter in detail with reference to the attached drawings, wherein the like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

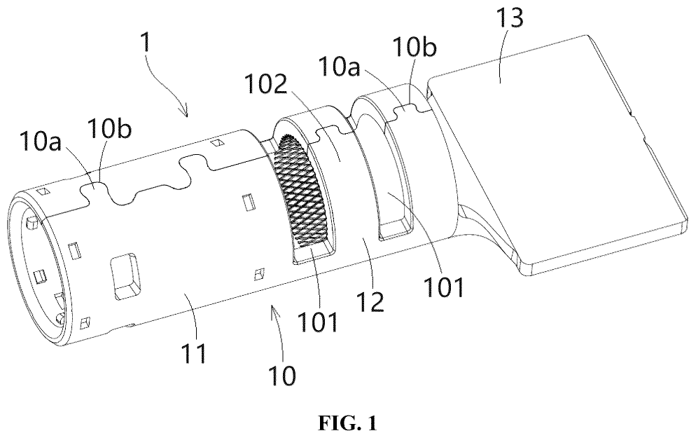

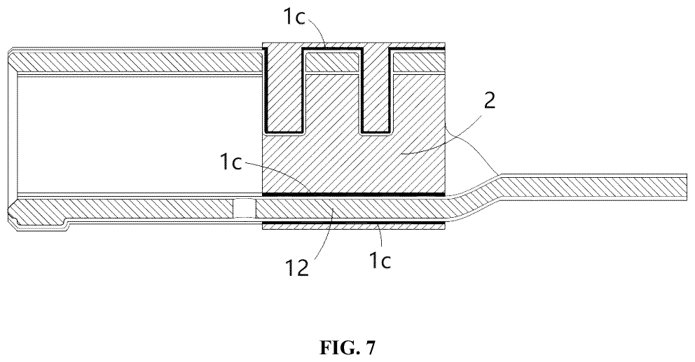

An exemplary embodiment of a terminal 1 will now be described with reference to FIGS. 1-8 and 12. The terminal 1 comprises a tubular body 10, as shown in FIG. 1, and a welding portion 13, as shown in FIGS. 1-4 and 8. As shown in FIGS. 1-4 and 12, the tubular body 10 has a front tubular portion 11 configured to mate with a mating terminal and a rear tubular portion 12 configured to be joined with an injection-molded seal 2 shown in FIG. 7. The welding portion 13 is connected to a rear end of the tubular body 10 and is configured to be welded to a conductor 30 of a power transmission member 3.

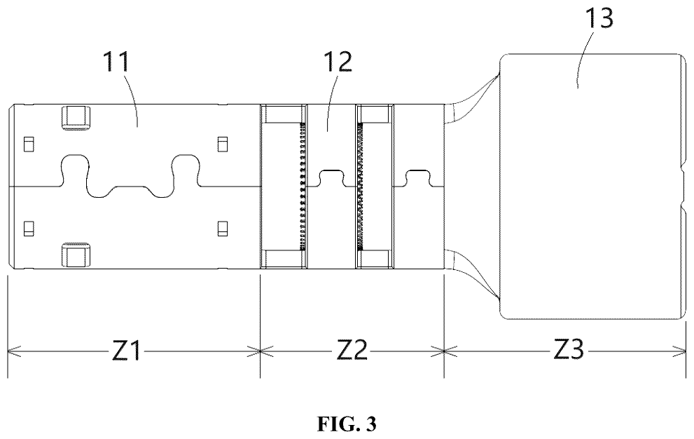

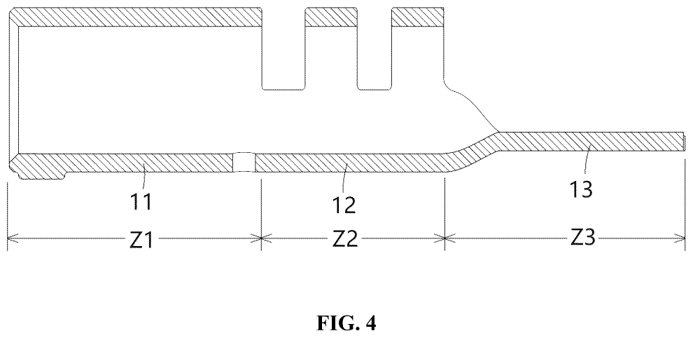

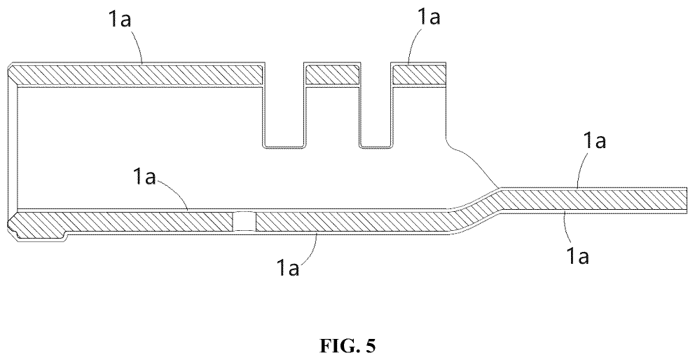

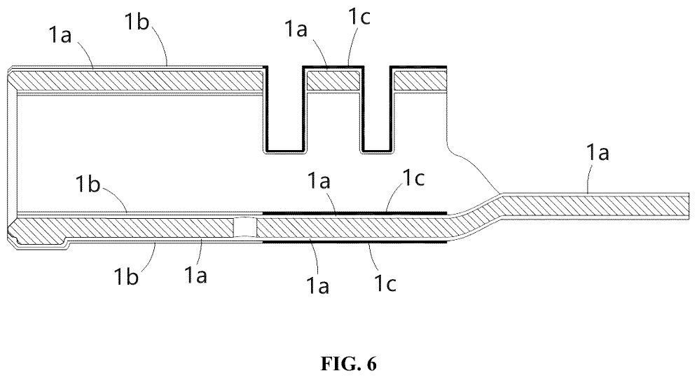

As shown in FIGS. 1-8, the terminal 1 is a one-piece stamped copper terminal. A nickel plating layer 1a, as shown in FIGS. 5-6 and 8, is formed on the entire terminal 1. The nickel plating layer 1a is a base plating layer of the terminal 1. As shown in FIGS. 3-4, the terminal 1 has a mating zone Z1 located at the front tubular portion 11, an injection molding zone Z2 located at the rear tubular portion 12, and a welding zone Z3 located at the welding portion 13. As shown in FIG. 6, a silver plating layer 1b is formed on the nickel plating layer 1a in the mating zone Z1 of the terminal 1, and a tin plating layer 1c is formed on the nickel plating layer 1a in the injection molding zone Z2 of the terminal 1.

As shown in FIG. 7, the tin plating layer 1c in the injection molding zone Z2 of the terminal 1 is configured to be engaged with the injection-molded seal 2 that is injection molded onto the rear tubular portion 12 of the terminal 1, to increase a joint strength between the terminal 1 and the injection-molded seal 2.

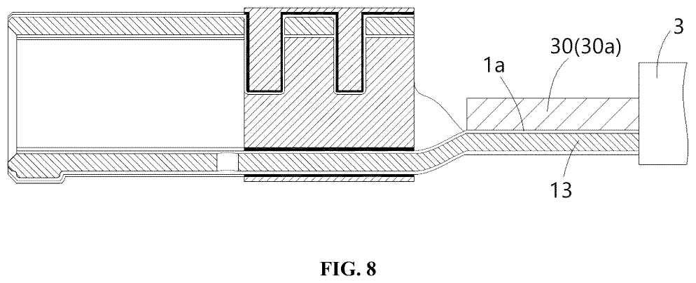

As shown in FIG. 8, the silver plating layer 1b in the mating zone Z1 of the terminal 1 is configured to make electrical contact with an elastic contact member 4 that is inserted into the front tubular portion 11 of the terminal 1, to improve the electrical contact performance between the terminal 1 and the clastic contact member 4.

In the embodiment of the terminal 1, as shown in FIGS. 1-8 and 12, no other plating layer is formed on the nickel plating layer 1a in the welding zone Z3 of the terminal 1.

As shown in FIG. 8, the conductor 30 of the power transmission member 3 is a copper conductor, and the copper conductor is configured to be welded to the nickel plating layer 1a in the welding zone Z3 of the terminal 1.

As shown in FIG. 1, an opening 101 is formed in the rear tubular portion 12 of the terminal 1. The opening 101 allows an injection molding material for forming the injection-molded seal 2 to enter an inner cavity of the rear tubular portion 12 of the terminal 1 through the opening 101, so as to seal the inner cavity of the rear tubular portion 12. The opening 101 is arc-shaped and extends in a circumferential direction of the rear tubular portion 12. As further shown in FIG. 1, a pair of openings 101 are formed in the rear tubular portion 12, and the pair of openings 101 are spaced apart in an axial direction of the rear tubular portion 12. Additionally, as shown in FIG. 1, the rear tubular portion 12 has an arc-shaped bridge 102 between the pair of openings 101, and the arc-shaped bridge 102 is configured to be embedded in the injection-molded seal 2 so as to be joined together with the injection-molded seal 2.

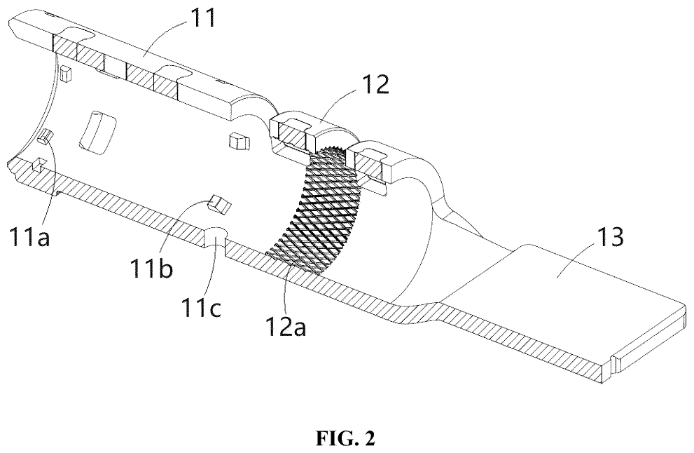

As shown in FIG. 2, a knurling pattern 12a is formed on an inner circumferential surface of the rear tubular portion 12 of the terminal 1. The knurling pattern 12a is configured to be joined with the injection molding material that enters the rear tubular portion 12 of the terminal 1, to increase a joint strength between the rear tubular portion 12 of the terminal 1 and the injection-molded seal 2.

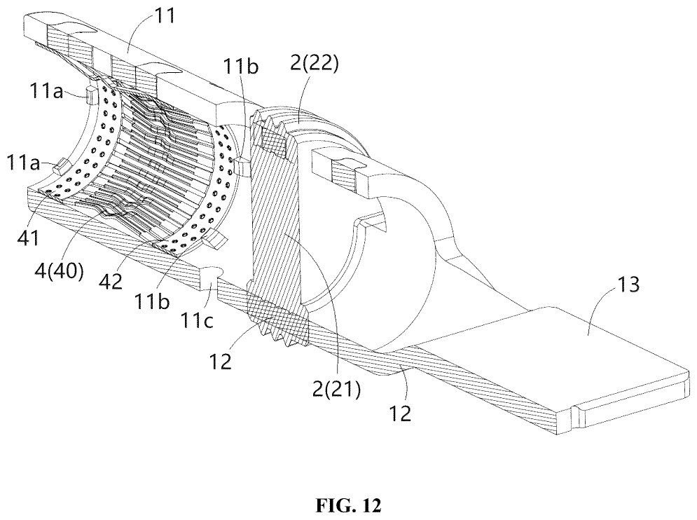

As shown in FIGS. 2 and 12, a plurality of first positioning protrusions 11a and a plurality of second positioning protrusions 11b are formed on an inner circumferential surface of the front tubular portion 11 of the terminal 1. The plurality of first positioning protrusions 11a are distributed at intervals in a circumferential direction of the front tubular portion 11, and the plurality of second positioning protrusions 11b are distributed at intervals in the circumferential direction of the front tubular portion 11. As shown in FIG. 12, the first positioning protrusions 11a and the second positioning protrusions 11b are opposite and spaced apart from each other in an axial direction of the front tubular portion 11 and are adapted to abut against a front end and a rear end, respectively, of the elastic contact member 4 that is inserted into the front tubular portion 11, to axially position the clastic contact member 4.

As shown in FIGS. 2 and 12, a drain hole 11c is formed in a peripheral wall of the front tubular portion 11 of the terminal 1 such that water entering the front tubular portion 11 of the terminal 1 can be discharged through the drain hole 11c.

As shown in FIG. 1, the tubular body 10 of the terminal 1 has a pair of side portions assembled together, and a plurality of engagement grooves 10b are formed in one of the pair of side portions and a plurality of engagement protrusions 10a are formed on the other one of the pair of side portions. The plurality of engagement grooves 10b are distributed at intervals in an axial direction of the tubular body 10, and the plurality of engagement protrusions 10a are distributed at intervals in the axial direction of the tubular body 10 and are respectively engaged with the plurality of engagement grooves 10b, so as to assemble the pair of side portions of the tubular body 10 together.

As shown in FIG. 1, the engagement grooves 10b and the engagement protrusions 10a are Ω-shaped, dovetail-shaped. The engagement grooves 10b and the engagement protrusions 10a may also be other suitable shapes.

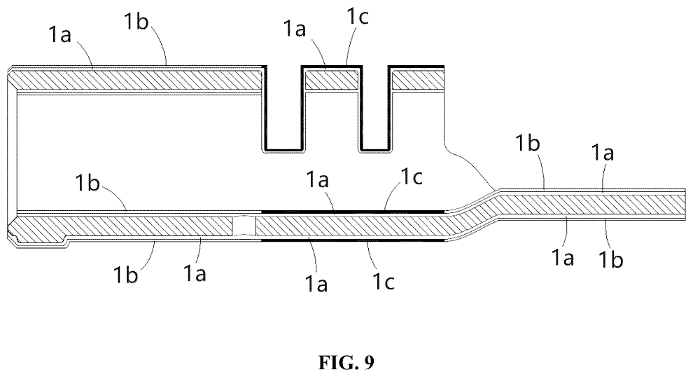

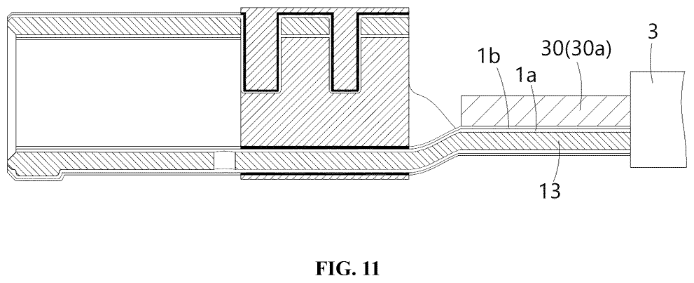

Another exemplary embodiment of the terminal 1 will now be described with reference to FIGS. 9-11. The embodiment of the terminal 1 according to FIGS. 9-11 differs from the embodiment of the terminal 1 according to FIGS. 1-8 in that a silver plating layer 1b, as shown in FIGS. 9 and 11, is formed on the nickel plating layer 1a in the welding zone Z3 of the terminal 1. Additionally, the conductor 30 of the power transmission member 3, as shown in FIG. 11, differs from the conductor 30 of the power transmission member 3 shown in FIG. 8 in that the conductor 30 of the power transmission member 3 shown in FIG. 11 is an aluminum conductor, and the aluminum conductor is configured to be welded to the silver plating layer 1b in the welding zone Z3 of the terminal 1.

As shown in FIGS. 5-10, the nickel plating layer 1a, the silver plating layer 1b and the tin plating layer 1c on the embodiment of the terminal 1 according to FIGS. 1-8 and 12 and the terminal 1 according to FIGS. 9-11, each have a uniform thickness, and the thickness of the silver plating layer 1b is equal to the thickness of the tin plating layer 1c.

An exemplary embodiment of a terminal assembly will now be described with reference to FIGS. 1-12. The terminal assembly comprises the embodiment of the terminal 1 according to FIGS. 1-8 and 12 and the injection-molded seal 2. Although the terminal assembly was described above with reference to the terminal 1 according to FIGS. 1-8 and 12, the terminal assembly may also comprise the terminal 1 according to FIGS. 9-11. Hereinafter, “either terminal 1” is intended to refer to both the embodiment of the terminal 1 according to FIGS. 1-8 and 12 and the embodiment of the terminal 1 according to FIGS. 9-11.

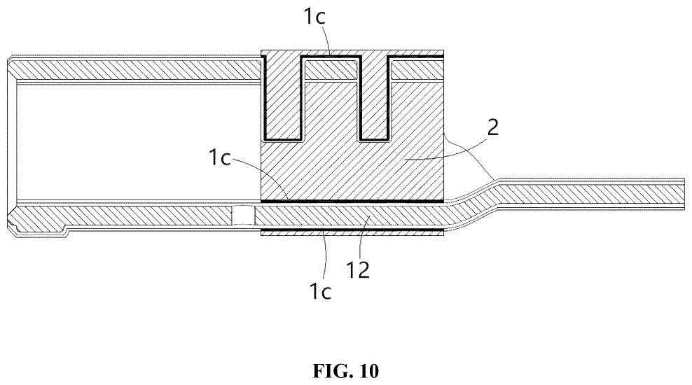

Either terminal 1 is adapted to be inserted into a terminal insertion hole of a housing of an electrical connection device. The injection-molded seal 2 is injection-molded onto the rear tubular portion 12 of either terminal 1, as shown in FIGS. 7 and 10, and is configured to seal the inner cavity of the rear tubular portion 12 and the terminal insertion hole of the housing.

As shown in FIG. 12, the injection-molded seal 2 comprises an inner sealing portion 21 and an outer sealing portion 22. The inner sealing portion 21 is located inside the rear tubular portion 12 of either terminal 1 and is configured to seal the inner cavity of the rear tubular portion 12. The outer sealing portion 22 is located outside the rear tubular portion 12 of either terminal 1, and is adapted to be pressed between the rear tubular portion 12 and an inner wall of the terminal insertion hole, and is configured to seal the terminal insertion hole of the housing. The inner sealing portion 21 is joined with the tin plating layer 1c on an inner circumferential surface of the rear tubular portion 12, and the outer sealing portion 22 is joined with the tin plating layer 1c on an outer circumferential surface of the rear tubular portion 12. The injection-molded seal 2 may be formed of a silicone material or other suitable injection molding material injection-molded onto the rear tubular portion 12 of either terminal 1.

As shown in FIG. 12, the terminal assembly further comprises an elastic contact member 4 inserted into the front tubular portion 11 of either terminal 1 and in electrical contact with the silver plating layer 1b on an inner circumferential surface of the front tubular portion 11. The clastic contact member 4 is configured for electrical contact with a mating terminal inserted into the front tubular portion 11 of either terminal 1, such that the mating terminal can be electrically connected to either terminal 1 via the elastic contact member 4.

As shown in FIG. 12, the clastic contact member 4 comprises a pair of annular end portions 41, 42 and a plurality of elastic arm portions 40. The plurality of clastic arm portions 40 are connected between the pair of annular end portions 41, 42. The plurality of clastic arm portions 40 are distributed at intervals in a circumferential direction of the annular end portions 41, 42 and are configured for electrical contact with an outer circumferential surface of the inserted mating terminal. The clastic contact member 4 may be a one-piece stamped copper component.

As shown in FIGS. 8 and 11, the terminal assembly further comprises a power transmission member 3 having a conductor 30 configured to be welded to the welding portion 13 of either terminal 1 to establish an electrical connection with either terminal 1.

The embodiment of the terminal 1 according to FIGS. 1-8 and 12, as shown in FIGS. 1-8 and 12, no other plating layer is formed on the nickel plating layer 1a in the welding zone Z3 of the terminal 1. Additionally, the conductor 30 of the power transmission member 3 is a copper conductor 30, and the copper conductor 30 is configured to be welded to the nickel plating layer 1a in the welding zone Z3 of the terminal 1.

The embodiment of the terminal 1 according to FIGS. 9-11, as shown in FIGS. 9-11, a silver plating layer 1b is formed on the nickel plating layer 1a in the welding zone Z3 of the terminal 1. Additionally, the conductor 30 of the power transmission member 3 is an aluminum conductor 30, and the aluminum conductor 30 is configured to be welded to the silver plating layer 1b in the welding zone Z3 of the terminal 1.

As shown in FIGS. 8 and 11, the welding portion 13 of either terminal 1 is flat, the conductor 30 of the power transmission member 3 has a flat welding end 30a, and the flat welding end 30a of the power transmission member 3 is configured to be welded to the flat welding portion 13 of either terminal 1.

An electrical connection device according to an exemplary embodiment will now be described with reference to FIGS. 1-12. The electrical connection device comprises a housing and the terminal assembly comprising either terminal 1. The housing is provided with a terminal insertion hole. The terminal assembly is inserted into the terminal insertion hole of the housing. The terminal assembly is configured for electrical contact with a mating terminal of a mating electrical connection device that is inserted into the terminal insertion hole, to electrically connect the electrical connection device and the mating electrical connection device.

The electrical connection device is a charging dock, and the mating electrical connection device is a charging gun adapted to mate with the charging dock. However, the present invention should not be construed as being limited to the embodiment set forth herein. For example, the electrical connection device may be a charging gun, and the mating electrical connection device may be a charging dock adapted to mate with the charging gun.

In the aforementioned exemplary embodiments according to the present invention, a silver plating layer 1b is formed in a mating zone Z1 of either terminal 1 that mates with a mating terminal, and a tin plating layer 1c is formed in an injection molding zone Z2 of either terminal 1 that is joined with an injection-molded seal 2. The good joint between the tin plating layer 1c in the injection molding zone Z2 of either terminal 1 and the injection-molded seal 2 can improve the waterproof sealing performance of either terminal 1. Moreover, since it is not necessary to form a silver plating layer 1b on the entirety of either terminal 1, the cost of either terminal 1 can be reduced.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a tubular body having a front tubular portion mating with a mating terminal and a rear tubular portion joined with an injection-molded seal; and
a welding portion connected to a rear end of the tubular body and welded to a conductor of a power transmission member, the terminal is a one-piece stamped copper terminal, and a nickel plating layer is formed on an entirety of the terminal, the nickel plating layer is a base plating layer of the terminal, the terminal has a mating zone at the front tubular portion, an injection molding zone at the rear tubular portion, and a welding zone at the welding portion, a silver plating layer is formed on the nickel plating layer in the mating zone, and a tin plating layer is formed on the nickel plating layer in the injection molding zone.

2. The terminal of claim 1, wherein the tin plating layer in the injection molding zone engages with the injection-molded seal that is injection molded onto the rear tubular portion.

3. The terminal of claim 1, wherein the silver plating layer in the mating zone electrically contacts an elastic contact member that is inserted into the front tubular portion.

4. The terminal of claim 1, wherein no other plating layer is formed on the nickel plating layer in the welding zone, the conductor of the power transmission member is a copper conductor, the copper conductor is welded to the nickel plating layer in the welding zone.

5. The terminal of claim 1, wherein a silver plating layer is formed on the nickel plating layer in the welding zone, and the conductor of the power transmission member is an aluminum conductor, the aluminum conductor is welded to the silver plating layer in the welding zone.

6. The terminal of claim 1, wherein an opening is formed in the rear tubular portion which allows an injection molding material for forming the injection-molded seal to enter an inner cavity of the rear tubular portion through the opening, the injection-molded seal seals the inner cavity of the rear tubular portion.

7. The terminal of claim 6, wherein the opening is arc-shaped and extends in a circumferential direction of the rear tubular portion, a pair of openings are formed in the rear tubular portion, the pair of openings are spaced apart in an axial direction of the rear tubular portion, the rear tubular portion has an arc-shaped bridge between the pair of openings, the arc-shaped bridge is embedded in the injection-molded seal so as to be joined together with the injection-molded seal.

8. The terminal of claim 6, wherein a knurling pattern is formed on an inner circumferential surface of the rear tubular portion, the knurling pattern is joined with the injection molding material that enters the rear tubular portion to increase a joint strength between the rear tubular portion and the injection-molded seal.

9. The terminal of claim 1, wherein the nickel plating layer, the silver plating layer, and the tin plating layer on the terminal each have a uniform thickness, and a thickness of the silver plating layer is equal to a thickness of the tin plating layer.

10. A terminal assembly, comprising:
a terminal, including a tubular body and a welding portion, the tubular body has a front tubular portion mating with a mating terminal and a rear tubular portion, the welding portion is connected to a rear end of the tubular body, the terminal is a one-piece stamped copper terminal, and a nickel plating layer is formed on an entirety of the terminal, the nickel plating layer is a base plating layer of the terminal, the terminal has a mating zone at the front tubular portion, an injection molding zone at the rear tubular portion, and a welding zone at the welding portion, a silver plating layer is formed on the nickel plating layer in the mating zone, and a tin plating layer is formed on the nickel plating layer in the injection molding zone, the terminal is inserted into a terminal insertion hole of a housing of an electrical connection device; and
an injection-molded seal injection-molded onto the rear tubular portion sealing an inner cavity of the rear tubular portion and the terminal insertion hole.

11. The terminal assembly of claim 10, wherein the injection-molded seal includes an inner sealing portion and an outer sealing portion, the inner sealing portion is inside the rear tubular portion and seals the inner cavity of the rear tubular portion, the outer sealing portion is outside the rear tubular portion and is pressed between the rear tubular portion and an inner wall of the terminal insertion hole, the outer sealing portion seals the terminal insertion hole, the inner sealing portion is joined with the tin plating layer on an inner circumferential surface of the rear tubular portion, and the outer sealing portion is joined with the tin plating layer on an outer circumferential surface of the rear tubular portion.

12. The terminal assembly of claim 10, wherein the injection-molded seal is formed of a silicone material injection-molded onto the rear tubular portion.

13. The terminal assembly of claim 10, further comprising an elastic contact member inserted into the front tubular portion and in electrical contact with the silver plating layer on an inner circumferential surface of the front tubular portion, the elastic contact member electrically contacts the mating terminal inserted into the front tubular portion such that the mating terminal is electrically connected to the terminal via the elastic contact member.

14. The terminal assembly of claim 13, wherein the elastic contact member includes a pair of annular end portions and a plurality of elastic arm portions connected between the pair of annular end portions, each elastic arm portion is distributed at intervals in a circumferential direction of the pair of annular end portions and electrically contact an outer circumferential surface of the inserted mating terminal.

15. The terminal assembly of claim 14, wherein the elastic contact member is a one-piece stamped copper component.

16. The terminal assembly of claim 10, further comprising a power transmission member having a conductor welded to the welding portion to establish an electrical connection with the terminal.

17. The terminal assembly of claim 16, wherein no other plating layer is formed on the nickel plating layer in the welding zone, the conductor of the power transmission member is a copper conductor, the copper conductor is welded to the nickel plating layer in the welding zone.

18. The terminal assembly of claim 16, wherein a silver plating layer is formed on the nickel plating layer in the welding zone, the conductor of the power transmission member is an aluminum conductor, the aluminum conductor is welded to the silver plating layer in the welding zone.

19. An electrical connection device, comprising:
a housing provided with a terminal insertion hole; and
a terminal assembly including a terminal and an injection-molded seal, the terminal includes a tubular body and a welding portion, the tubular body has a front tubular portion mating with a mating terminal and a rear tubular portion, the welding portion is connected to a rear end of the tubular body and welded to a conductor of a power transmission member, the terminal is a one-piece stamped copper terminal, and a nickel plating layer is formed on an entirety of the terminal, the nickel plating layer is a base plating layer of the terminal, the terminal has a mating zone at the front tubular portion, an injection molding zone at the rear tubular portion, and a welding zone at the welding portion, a silver plating layer is formed on the nickel plating layer in the mating zone, and a tin plating layer is formed on the nickel plating layer in the injection molding zone, the terminal is inserted into the terminal insertion hole, and the injection-molded seal is injection-molded onto the rear tubular portion sealing an inner cavity of the rear tubular portion and the terminal insertion hole, the terminal assembly is inserted into the terminal insertion hole, the terminal assembly electrically contacts the mating terminal of a mating electrical connection device that is inserted into the terminal insertion hole, to electrically connect the electrical connection device and the mating electrical connection device.

20. The electrical connection device of claim 19, wherein the electrical connection device is a charging dock and the mating electrical connection device is a charging gun mating with the charging dock, or the electrical connection device is a charging gun and the mating electrical connection device is a charging dock mating with the charging gun.
